(19) United States
(12) Patent Application Publication
(10) Pub. No.: US 2024/0059589 A1
(43) Pub. Date: Feb. 22, 2024

(54) DEVICE AND METHOD FOR STERILISING A FLUID FLOWING THERETHROUGH

(71) Applicant: OSRAM GmbH, Muenchen (DE)

(72) Inventors: Ulrich HARTWIG, Berlin (DE); Norbert MAGG, Berlin (DE); Andreas LOVICH, Augsburg (DE)

(21) Appl. No.: 18/270,625

(22) PCT Filed: Dec. 13, 2021
(86) PCT No.: PCT/EP2021/085441

§ 371 Date: Jun. 30, 2023

(30) Foreign Application Priority Data
Jan. 5, 2021 (DE) 10 2021 200 037.1

(51) Int. Cl. C02F 1/32

(52) U.S. Cl. CPC C02F 1/325; C02F 2201/3227; C02F 2201/3222; C02F 2301/043; C02F 2303/04; C02F 2209/11

(57) ABSTRACT

A device for sterilising a fluid flowing therethrough by comprises a container having an inlet for receiving the fluid and an outlet for discharging the fluid, a variable or adjustable irradiation zone for irradiating the fluid with UV radiation. The irradiation zone including a gap which extends between two oppositely arranged walls. The distance between the walls, and thus the gap size of the gap, can be changed by at least one wall being movable. For example, the wall is a wall of a displaceable body that is located inside the container or projecting into the container. By adjusting the distance between the walls in the region of the gap, and thus the layer thickness of the fluid flowing through the gap, the efficiency of the operation of the device is optimised with different scattering and absorption properties of the fluid.

The present invention relates to a device and to a corresponding method for sterilizing a fluid flowing through, in particular a liquid flowing through. The device comprises a container having an inlet for receiving the fluid and having an outlet, at which the fluid can be discharged from the container after flowing through. The device furthermore comprises a multiplicity of radiation sources, preferably LEDs, each of which is designed to irradiate the fluid flowing in an interior of the container with light having wavelengths in the range of UV radiation, preferably UV-C radiation. Such devices are also referred to as UV reactors.

UV reactors may be used in a variety of ways, for instance to treat drinking water or for the sterilization or disinfection of service water or process water which is used, for example, in commercial, agricultural or domestic applications (for example dishwashers, etc.). Fluids other than water, for example blood or milk, may also be sterilized by such UV reactors.

Radiation in the wavelength range from 200 nm to 280 nm, which according to DIN 5031-7 is also referred to as far-UV or FUV radiation, proves particularly effective in this case. In addition, there is the neighboring range of from 100 nm to 200 nm, which is correspondingly referred to as vacuum-UV or VUV radiation.

The wavelength ranges indicated above, of up to 280 nm, are referred to in the present application as UV-C radiation, that from 280 nm to 315 nm as UV-B radiation and that from 315 nm to 380 nm as UV-A radiation, and they are predominantly used in UV reactors. For the purposes of this application, the range of from 10 nm to 121 nm (extreme ultraviolet) is also included by the term UV-C radiation used here.

For efficient sterilization, the beam dose per unit volume of the liquid flowing through should in this case be a constant. At least, the beam dose per unit volume of the liquid flowing through should however lie above a limit value that ensures intended sterilization of the respective unit volume.

The efficiency of UV reactors for the sterilization of liquids is influenced by the penetration depth of the radiation into the liquid volume. Particularly in the case of UV-C radiation and turbid media, the incident light intensity already drops to a few percent by absorption and/or scattering after a few millimeters, so that a relevant disinfection effect cannot be achieved for irradiated layer thicknesses of a few cm or more, or a very high initial optical power would have to be used in order to achieve a sufficient effect after the attenuation. The turbidity of a medium may, for example, be caused by scattering or absorbing particles. These may be organic or inorganic in origin. Examples might be dirt particles, microorganisms, algae or suspended particles, limescale particles or the like. Alternatively or in addition, turbidity may also be caused by emulsions or mixing with other liquids (for example with colloidal constituents).

In order to ensure the condition of constant dose throughout the entire volume, special precautions are therefore necessary. This is especially true when the penetration depth of the radiation varies in the course of time.

By a suitable increase of the radiation power beyond a critical threshold value, for example by more than a factor of 10⁴, a radiation power sufficient for the reduction of propagable germs may in principle be achieved in all regions of the liquid that are to be disinfected. Many sterilization cells have been based in the past on UV-C lamp sources, in particular gas discharge lamps. Massive overdosing of the required radiation is possible in this case, since the costs of the sources per watt of radiation power are low and the radiation sources are in principle capable of emitting large amounts of radiation (several hundreds to several thousands of watts, depending on the type of lamp). In the simplest case, when designing the sterilization system, the “worst case” may be assumed (liquids that are as turbid as possible) and the reactor and the radiation source may be designed for this case. This solution approach, however, leads to a great reduction of the energy efficiency of the system because of UV overdosing in a large part of the irradiated region. In LED-based applications, this solution approach would not be viable because of the very low maximum amounts of UV radiation and the high costs of current UV LEDs, in particular UV-C LEDs.

It is therefore an object of the invention to develop a device of the type in question for sterilizing a fluid flowing through, in such a way that the aforementioned disadvantages are overcome. In particular, the sterilizing effect is intended to be ensured as efficiently as possible even in the case of a varying penetration depth, for example due to changing scattering and absorption properties of the liquid to be sterilized.

The object is achieved by a device for sterilizing a liquid flowing through, which has the features of patent claim 1. The dependent claims relate to advantageous developments of the device according to the invention.

The starting point is a device for sterilizing a fluid flowing through by means of UV radiation, which comprises a container having an inlet for receiving the fluid and having an outlet, at which the fluid can be discharged from the container after flowing through. Essentially, it is therefore a flow reactor. The invention likewise includes a fluid held in the container, which is previously introduced, sterilized by means of UV radiation, and subsequently released. In what follows, the container of the device, that is to say of the UV reactor, will sometimes also be referred to as a reactor chamber.

A sensor device may furthermore be provided, which detects the penetration depth of the radiation by sensing, for example by means of a turbidity sensor, and adapts the reactor chamber dimensions so that a sufficient sterilizing power is ensured even in the event of increasing turbidity. Furthermore, the throughput rate may also be adapted or readjusted. Excessively crude overdosing or insufficient dosing of the radiation may thus be prevented.

The throughput rate may be adjusted by controlling the pressure, for example by means of a controllable valve or the power consumption of a pump that pumps the fluid through the UV reactor. The control may, for example, be carried out as a function of the measurement result of a turbidity sensor.

The adaptation of the reactor chamber dimensions may, for example, be carried out so that the layer thickness of the liquid flowing past the radiation sources is adapted by varying the distance between the reactor walls that delimit this irradiation zone, for example with the aid of a displacement unit. In the case of high extinction, that is to say a low penetration depth of the radiation, the distance between the reactor walls and consequently the layer thickness of the fluid in the irradiation zone is reduced appropriately. Conversely, in the case of low extinction, that is to say a higher penetration depth of the radiation, the distance between the reactor walls and consequently the layer thickness of the fluid may be increased appropriately. Furthermore, the throughput rate may be adapted accordingly in order to achieve the desired irradiation dose throughout the entire volume of the irradiation zone. This may, for example, be done by readjustment of the volume flow or the pressure in the inlet of the reactor.

In various exemplary embodiments of the invention, the variable irradiation zone is formed by a wall of the reactor container (first reactor wall) and a wall of a displaceable body (second reactor wall)—in what follows, the displaceable body will also be referred to as a slider for the sake of simplicity. In this case, the displaceable body (slider) is arranged inside the reactor container so that the wall of the slider (slider wall) and the wall of the container (container wall) face one another. The shapes of the container wall and of the slider wall are in this case preferably matched to one another inside the irradiation zone so that a gap that is as uniform as possible for the fluid flowing through is formed between them, at least in sections, that is to say a gap having a consistent, constant gap dimension. In the case of a uniform gap, with uniform radiation, a uniform sterilizing effect of the fluid flowing through may be achieved inside the irradiation zone. Alternatively, with a radiation power correspondingly adapted locally, a uniform sterilizing effect may also be achieved with a nonuniform gap.

The walls that form the gap, or the irradiation zone, may for example both be plane or spatially curved, in the latter case the curvatures of the two walls preferably being complementary so that an appropriately spatially curved gap that is as uniform as possible is formed. For further details in this regard, reference is made to the preferred embodiments of the invention which follow.

By displacing the slider, the gap dimension, that is to say the distance between the container wall and the slider wall, may be suitably adjusted and if necessary altered. Furthermore, the container wall, the slider wall and the displacement unit are preferably designed so that the gap dimension varies uniformly inside the entire gap-shaped irradiation zone.

The slider may be mechanically connected to the displacement unit, for example arranged directly on the displacement unit. The displacement unit may for example be a linear guide rail, in which the slider is movably supported, arranged on the bottom inside the reactor. The coupling between the slider and the displacement unit may also take place in another way, for example magnetically through the wall of the reactor container.

Advantageously, the movement of the slider may also be carried out purely by the force of the flowing liquid. For this purpose, liquid is guided via a regulatable bypass onto the rear side of the slider facing away from the inlet (lee side). Increasing liquid pressure in the bypass correspondingly displaces the slider a little way against the main flow of the liquid coming directly from the inlet. For the restoring forces in the event of a decreasing liquid pressure, retaining springs, damping or restoring elements, or the like, are provided, on which the slider is resiliently suspended in the container. So that the displacement of the slider by the respective liquid pressure in the main flow or the bypass causes an appropriate change of the gap dimension, the slider is supported by the retaining springs in the neutral state at a suitable working point, for example approximately in the middle of the reactor. For further details in this regard, reference is made to the exemplary embodiments.

In alternative embodiments according to the invention of the variable irradiation zone, at least one body that can be displaced through the container wall is provided, by which an adjustable constriction for the fluid flow is formed. In the simplest case, this displaceable body is a gliding wall that is designed so that it can be inserted into the container or retracted therefrom in the region of the irradiation zone in the manner of a bolt. The gap of the variable irradiation zone is in this case formed between the end side of the gliding wall, which is located inside the container, and the opposite container wall. The gap dimension is adjusted suitably by the corresponding displacement of the gliding wall in relation to the container wall.

For the irradiation zone, the UV radiation sources may be arranged only on the side of the container wall. In this case, the gliding wall only has a mechanical function and may be configured relatively simply, and for example solidly. Alternatively, the UV radiation sources may be arranged on or behind the end side of the gliding wall, or integrated therein. This has the advantage over the first case that no radiation is emitted past the gliding wall, and the irradiation zone and its gap dimension are thus more clearly defined.

In one development, two gliding walls that face one another with their end sides are provided. Particularly advantageously, the two gliding walls may be displaced on either side of the container respectively by the same amounts, in order to ensure symmetry of the reactor.

In these embodiments, with one gliding wall (asymmetric variant) or with two gliding walls that face one another (symmetrical variant), relatively simply adjustable constrictions for the liquid flow may be produced. They are therefore particularly suitable for irradiation zones that are relatively short in the flow direction, for example from a few millimeters to a few centimeters.

In the sensor device, a sensor which measures the radiation that passes through the reactor chamber in the irradiation zone may be provided. Alternatively or in addition, an additional auxiliary radiation source with an associated radiation sensor may also be provided outside the irradiation zone. Whatever the case, the measurement value of the radiation sensor is a measure of the turbidity and may then be used to control the reactor chamber dimensions for a suitable layer thickness of the liquid flowing past the radiation sources. For this purpose, for example, the measurement signal of the sensor may be delivered to the controller of the displacement unit.

Semiconductor UV radiation sources, in particular UV-C LEDs, are preferred as UV radiation sources since they have a number of advantages over conventional UV light sources such as mercury vapor discharge lamps, for example freedom from mercury, small overall size, good drivability and fast switching times, mechanical stability and long lifetime, etc.

In various exemplary embodiments, the UV radiation sources, for example UV-C LEDs, and the sensor device are respectively arranged in the region of two reactor walls that face one another, between which the liquid flows. For this purpose, the reactor walls are configured to be transparent for the UV-C radiation, at least in the region of the LEDs and optionally of the radiation sensor. For example, the reactor walls may also be provided with UV-C transparent windows through which the LEDs emit the UV-C radiation into the interior of the reactor chamber. The measurement signal of the radiation sensor is then a measure of the extinction of the UV radiation after traveling along the path between the two reactor walls. The distance between the two reactor walls may then be adapted as a function of this measurement value, in order to achieve the desired sterilizing effect. Preferably, this adaptation of the distance is carried out automatically on the basis of the sensor measurement value.

For a desired minimum UV-C radiation dose (dose=intensity/time), the liquid flow may be adapted, for example by means of a regulatable valve with which the amount of liquid flowing through the reactor per unit time can be regulated. In order to control the valve, the measurement signal from the sensor and/or the position of the reactor walls that is adjusted by the displacement unit may be used.

If the UV-C sensor measures an intensity of 1000 W/m², for example, by virtue of the known geometrical and optical properties of the UV-C reactor, the minimum average irradiation intensity of a volume element on possible trajectories through the reactor is also known, for example by simulations or measurements of the sterilizing power. With this information, a particular flow rate or a particular volume flow may then be adjusted for a desired dose, for example 400 J/m².

In one development, the UV radiation sources in the irradiation zone are arranged not only on one side but in the region of both reactor walls that face one another, between which the liquid flows, so that one part of the UV radiation sources emits in the opposite direction to the other part of the UV radiation sources. In this way, in the event of absorption and scattering by the liquid, a more uniform intensity distribution in the irradiation zone of the reactor may on the one hand be achieved. On the other hand, the distance between the two reactor walls may also correspondingly be increased without reductions of the sterilizing effect.

The UV radiation sources in the region of the other reactor wall lying opposite may also be arranged slightly offset downstream. The sensor device may then still be arranged directly opposite the UV radiation sources of the one reactor wall and measure the extinction of the radiation emitted by these UV radiation sources. This arrangement furthermore makes it possible to switch on the UV radiation sources arranged offset downstream on the other side only in the case of a correspondingly high extinction, that is to say a corresponding measurement signal from the sensor device.

By the described adaptation of the distance between the walls of the reactor chamber in the region of the gap-shaped irradiation zone, and therefore of the layer thickness of the liquid flowing through the gap between the walls, efficiency-optimized operation of the UV reactor is achieved in the event of different scattering and absorption properties of the liquid.

Of course, a plurality of devices or UV reactors according to the invention may be arranged in parallel or in series in order to be able to irradiate larger amounts of fluid simultaneously by corresponding distribution, or to improve the degree of sterilization in stages.

### BRIEF DESCRIPTION OF THE DRAWINGS

FIG. 1 shows a schematic representation of a detail of a UV flow reactor with unilateral UV irradiation according to the present invention;

FIG. 2 shows a schematic representation of a detail of a UV flow reactor with bilateral UV irradiation according to the present invention;

FIG. 3 shows a schematic representation of a sectional view of an exemplary embodiment of the invention with a mobile wedge-shaped slider;

FIG. 4 shows a schematic representation of a sectional view of an exemplary embodiment of the invention with a mobile conical slider;

FIG. 5 shows a schematic representation of a sectional view of a further exemplary embodiment of the invention with a mobile conical slider;

FIG. 6 shows a schematic representation of a detail of a further exemplary embodiment of a UV flow reactor according to the invention with a gliding wall.

### PREFERRED EMBODIMENTS OF THE INVENTION

Features that are the same or of the same type may also be denoted below with the same references for the sake of clarity.

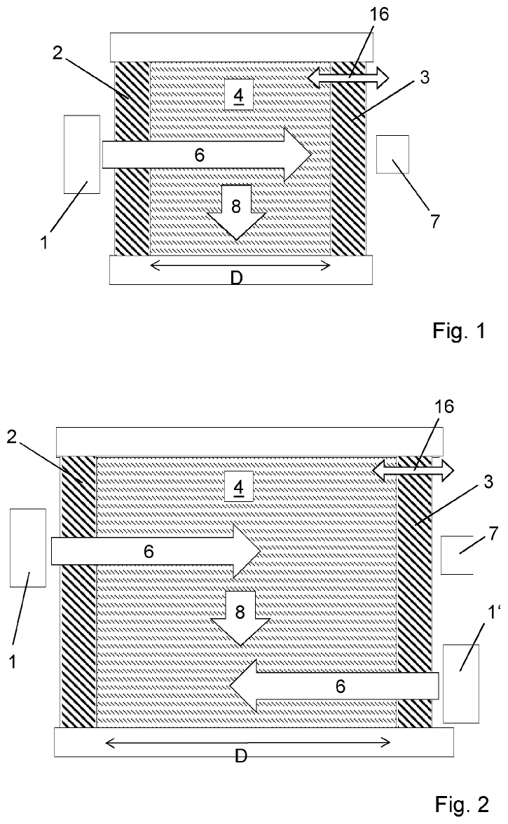

FIG. 1 shows a schematic representation of a detail of a UV flow reactor in order to illustrate the basic concept of the present invention. This detail is a UV flow reactor with unilateral UV irradiation of the liquid layer. A UV radiation source 1, which preferably comprises a multiplicity of UV-C LEDs, emits into a reactor chamber (only a detail is represented). The radiation 6 enters through a first reactor wall 2, which is transmissive for UV radiation, into the reactor chamber and travels across the latter as far as the reactor wall 3 lying opposite at the distance D. A liquid 4, the flow direction of which is symbolized by the arrow 8, flows between the reactor walls 2, 3. The radiation 6 is thereby attenuated transversely with respect to the flow layer in the reactor. Possible causes are absorption and scattering by the liquid 4. Arranged on the opposite second reactor wall 3, there is a sensor 7, for example an SiC (silicon carbide) UV photodiode, which measures the radiation 6 arriving there. In the case of high extinction, according to the invention provision is made to reduce the distance between the reactor walls 2, 3, and consequently the layer thickness D of the liquid 4, to such an extent that the radiation power measured with the sensor 7 ensures sufficient sterilization of the liquid 4. For this purpose, for example, the second reactor wall 3 is designed to be displaceable, specifically in the direction toward the first reactor wall 2 arranged opposite. The displaceability of the second reactor wall 3 is indicated by the double arrow 16.

Provision may furthermore be made that the liquid flow is adaptable, for example by means of a regulatable valve or an adjustable pump (not represented in FIG. 1), with which the amount of liquid flowing through the reactor per unit time can be regulated.

FIG. 2 schematically shows a development of the concept representation of FIG. 1, here with a second UV radiation source 1′ emitting into the reactor in the opposite direction (indicated by the arrows 6) through the second reactor wall 3. This detail is thus a UV flow reactor with bilateral UV irradiation of the liquid layer. In this way, as represented, for the same degree of turbidity the distance D between the two reactor walls 2, 3 may be correspondingly increased compared to the arrangement with unilateral UV irradiation in FIG. 1, without reductions of the sterilizing effect. In the event of decreasing turbidity, the second UV radiation source 1′ may also be turned off again under the control of the measurement signal of the sensor 7 in order to save energy, so long as the sterilizing effect is then still sufficient. Alternatively, the second UV radiation source 1′ may also be used in order to achieve a more uniform UV intensity distribution transversely with respect to the flow direction of the liquid layer in the reactor.

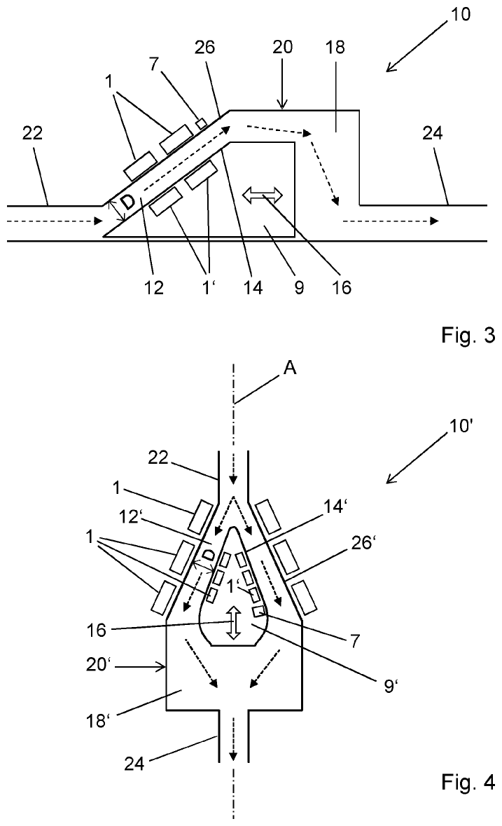

FIG. 3 shows a schematic representation of a sectional view of an exemplary embodiment of the invention with a mobile wedge-shaped slider for changing distance between the walls that delimit the liquid layer. A reactor 10 having a container 20 and an inlet 22 as well as an outlet 24 for a liquid to be sterilized is represented. The liquid flowing in and the liquid flowing out are symbolized by corresponding arrows and dashed lines. The inlet 22 is formed at one end of the container 20, and the outlet 24 is formed in rectilinear continuation at the other end of the container 20. The inlet 22 is followed by a first reactor region 12, in which the layer thickness D of the liquid flowing through is variable. For this purpose, the container 20 has an oblique container wall 26 (first reactor wall) as well as a wedge-shaped slider 9 arranged in the interior of the container 20 and having a likewise oblique slider wall 14 (second reactor wall) parallel to the oblique container wall 26. By displacement of the wedge-shaped slider 9 to and fro in the direction from the inlet 22 to the outlet 24 and in the opposite direction, symbolized by the double arrow 16, the gap dimension D between the two oblique walls 14 and 26, and therefore the layer thickness of the liquid flowing between them, is respectively increased or decreased. In order to make the displacement of the slider 9 between the intended minimum and maximum gap dimensions D possible, a second reactor region 18 is provided, into and from which the slider 9 can be inserted and retracted as appropriate. The liquid flowing through the first reactor region 12 flows via the second reactor region 18 and finally the outlet 24 out of the container 20 of the reactor 10. The UV irradiation of the liquid layer adapted according to the gap dimension D takes place by means of the UV-C LEDs 1 and 1′, which are respectively arranged on either side in the region of the oblique container wall 26 and the oblique slider wall 14. For this purpose, the aforementioned regions are configured to be transparent for the UV-C radiation at least in the immediate vicinity of the LEDs. It is thus a UV flow reactor with bilateral UV irradiation of the liquid layer, the first reactor region 12 being designed as an irradiation zone.

Arranged in the region of the oblique container wall 26, there is furthermore a UV sensor 7 which measures the UV-C radiation arriving through the liquid, which is emitted by the LEDs 1′ arranged in the region of the opposite oblique slider wall 14. Preferably, the reactor 10 is designed (this is not represented) for the adaptation of the gap dimension D to be carried out automatically with the aid of the measurement values of the UV sensor 7, by the slider 9 being displaced correspondingly by means of suitable control. Likewise, corresponding manual displacement of the slider 9 is also included according to the invention.

The slider may be moved mechanically by means of a displacement unit, for example using linear positioning systems widely known in the prior art, for example via a threaded worm or a rack, which is moved by means of an electric motor (this is not represented). Alternatively, piezo actuators may also be used, for example in so-called stick-slip drives. The reactor then preferably consists of a metal housing, on which the slider can be mounted, and has a UV-transparent window for introducing the UV radiation. The materials of the drive system should in this case be selected so that corrosion by small amounts of water possibly entering is avoided. A magnetic force may also be produced through the reactor wall. In this case, a magnet which is carried along by a mobile magnet outside the reactor may be firmly installed in the slider. An advantage of a magnetic drive is that leaks of the reactor are precluded and no corrosion of the drive system can occur. Such a drive system is preferred particularly in reactors in which the liquid is irradiated from all three spatial directions, for example in the following exemplary embodiment.

FIG. 4 shows a schematic representation of a sectional view of an exemplary embodiment of the invention with a mobile conical slider 9′ having a conical section 14′ (conical slider wall 14′). The mobile conical slider 9′ is used to alter the distance D between the walls 14′, 26′ that delimit the liquid layer of a reactor 10′, which is rotationally symmetrical with respect to the axis A. For this purpose, in a first region 12′ of the reactor 10′, namely the irradiation zone, the wall 26′ of the container 20′ (container wall 26′) of the reactor 10′ is formed in the shape of a funnel. The funnel shape of the container wall 26′ and the conical shape of the slider wall 14′ (conical section of the slider 9′) are in this case matched to one another so that a circumferential gap is formed between the funnel-shaped container wall 26′ and the facing conical slider wall 14′ in the first reactor region 12′. This gap is used as an irradiation zone. Different gap dimensions D between the funnel-shaped container wall 26′ and the conical slider wall 14′ may be adjusted by axial displacement (symbolized by the double arrow 16) of the conical slider 9′ along the rotation axis A.

With the aid of the gap dimension D that can be adjusted in this way, the layer thickness of the fluid to be irradiated flowing through the gap (again symbolized by corresponding arrows with dashed lines) may be adapted directly to possibly changing conditions, for example turbidity of the fluid. It is therefore substantially possible to adjust an optimal gap dimension under different conditions with a view to the highest possible throughput (larger gap dimension) and adequate efficiency of the sterilization, that is to say penetration depth of the radiation into the fluid (smaller gap dimension).

The UV irradiation of the liquid layer adapted according to the gap dimension D is carried out by means of UV-C LEDs 1, 1′, which are arranged both in the first reactor region 12′ of the funnel-shaped container wall 26′ (LEDs 1) and the conical slider wall 26′ (LEDs 1′). This is thus also a UV flow reactor 10′ with bilateral UV irradiation of the liquid layer, the first reactor region 12′ being designed as an irradiation zone. For this purpose, the aforementioned regions are configured to be transparent for the UV-C radiation at least in the immediate vicinity of the LEDs.

A UV radiation sensor 7 is furthermore provided, which detects changes of the turbidity of the fluid and forwards the measurement signals to a controller for adjustment of the suitable gap dimension D by displacement 16 of the slider 9′. Corresponding gap dimensions D for different fluid properties, in particular degrees of turbidity, may be stored in the controller.

The first reactor region 12′ with the funnel-shaped container wall 26′ is followed by a cup-shaped second reactor region 18′, into or out of which the slider 9′ can be moved during a change of the gap dimension D. Provided at the end of the cup-shaped reactor region 18′, there is an outlet 24 through which the liquid flowing in at the inlet 22 can flow back out of the container 20′ of the reactor 10′ after it has flowed through the first reactor region 12′ and has been irradiated with UV radiation there.

Advantageously, the movement of the slider may also be carried out purely by the force of the flowing liquid. In this case, none of the drive systems mentioned above is necessary, and there is then also no risk of a leak of the reactor or of corrosion of drive components. For this purpose, the mobile conical slider 9′ is suspended by means of retaining springs inside the container 20′ and, in the neutral state, is supported at a suitable working point, for example approximately in the middle of the reactor (this is not represented here for the sake of better clarity). The spring forces on the one hand and the water force on the other hand may therefore be used to regulate the throughput rate. The effect of an increasing water pressure on the inlet side 22 is that the slider 9′—depending on the spring forces selected —moves a little way in the direction toward the outlet side 24. The water pressure and therefore the throughput rate in the gap-shaped irradiation zone 12′ are thereby reduced. When the water pressure on the inlet side 22 decreases again, the slider 9′ moves back a little way in the direction toward the inlet side 22 because of the spring forces and counteracts a reduction of the throughput rate in the gap-shaped irradiation zone 12′. As soon as a liquid flows into the reactor, the slider is thus moved away from the inlet and ensures adaptation of the liquid pressure and therefore the throughput rate. By means of the turbidity sensor 7 and a drivable valve (not represented), the positioning of the slider 9′ may then in turn be adjusted by adjusting the liquid pressure.

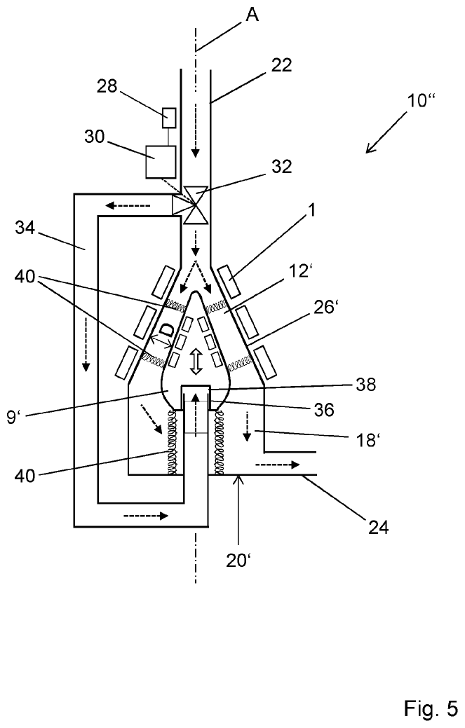

FIG. 5 shows a schematic representation of a sectional view of a variant of the exemplary embodiment of FIG. 4, in which a turbidity change can also be compensated. For this purpose a sensor 28 is provided, which measures the turbidity and forwards the measurement signal to a control unit 30 for a three-way valve 32. With the aid of the three-way valve 32, a part of the liquid flow coming from the inlet can be branched off into a bypass tube 34. The bypass tube 34 is used to bring the liquid pressure to the rear side facing away from the main flow (lee side) of the conical slider 9′. For this purpose, the free end of the bypass tube 34 is guided by means of a slide bearing 36 into a cylindrical indentation 38 of the conical slider 9′. Alternatively, a flexible hose, for example similar to a concertina, may be used for the connection between the bypass tube and the mobile slider (this is not represented).

Furthermore, the conical slider 9′—as already mentioned in the description of FIG. 4 but not represented there—is resiliently suspended inside the container 20′ by means of retaining springs 40. Depending on the ratio of the water pressures adjusted with the aid of the three-way valve 32 in the gap-shaped irradiation zone 12′ (main flow) and respectively in the indentation 38 of the slider 9′ (bypass flow 34), the slider 9′ moves a little way in the direction of the main flow or in the opposite direction (indicated by the double arrow). In the first case, the gap dimension D in the gap-shaped irradiation zone 12′ increases, and in the second case the gap dimension D decreases.

Preferably, the control of the three-way valve 32 is carried out as a function of the measurement signal of the turbidity sensor 28. For this purpose, the control unit 30 is designed to drive the three-way valve 32 in the event of increasing turbidity so that it guides an increasing part of the liquid via the bypass tube onto the rear side of the slider and therefore builds up an increasing pressure in the bypass flow 34. The conical slider 9′ is thereby pressed a little way in the direction toward the inlet 22 while reducing the gap dimension D, or the fluid layer thickness in the gap-shaped irradiation zone 12′. For this purpose, for example, value pairs for different measurement values of the degree of turbidity of a fluid and the respectively associated control signals for the three-way valve 32, corresponding to suitable gap dimensions D, are stored in the control unit 30. Alternatively, a control curve as a function of the degree of turbidity may be provided. Furthermore, a warning signal may also be emitted by the control unit if the measured degree of turbidity exceeds a limit value.

The shapes of the reactors 10, 10′, 10″ as shown in FIGS. 3 to 5 are to be understood purely by way of example. Depending on the application case or specific configuration, other shapes may also be expedient. For example, the substantially rotationally symmetrical reactors 10′, 10″ in the exemplary embodiments according to FIGS. 4 and 5 may also be constructed in the manner of the reactor 10 shown in FIG. 3, that is to say asymmetrically with a slider, which is for example movably supported in a linear guide rail, arranged on the bottom of the reactor. Such a bearing may then at least partially replace the retaining springs 40 shown in FIG. 5. It is then also conceivable to use encapsulated damping or restoring elements, for example in the manner of a shock absorber, which are embedded in the linear guide rail.

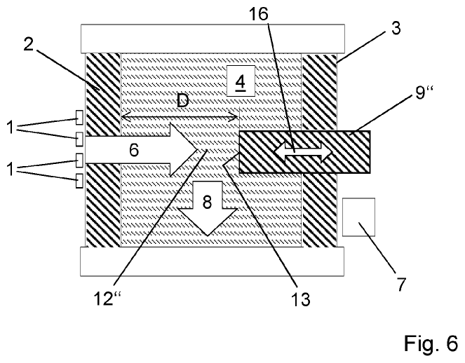

FIG. 6 shows a schematic representation of a detail of a further exemplary embodiment of a UV flow reactor according to the invention. This detail is a development of the UV flow reactor represented in FIG. 1 with unilateral UV irradiation of the liquid layer in the irradiation zone 12″. For the UV radiation 6 in the irradiation zone 12″, a multiplicity of UV-C LEDs 1 are provided, which are arranged on the first reactor wall 2. The development consists substantially in the adaptation of the distance D being locally limited to the irradiation zone 12″. In other words, the irradiation zone 12″ is designed as an adjustable constriction for the liquid flow 4. For this purpose, a plane gliding wall 9″ is provided, which can be inserted at least partially into the irradiation zone 12″, or retracted therefrom, opposite the multiplicity of UV-C LEDs 1 through a suitable opening of the opposite reactor wall 3, for example with the aid of a displacement unit (not represented). The displacement 16 (indicated by the double arrow) of the gliding wall 9″ is in this case carried out transversely with respect to the flow direction 8 of the liquid 4 flowing between the gliding wall 9″ and the opposite reactor wall 2, that is to say in the direction toward the wide side of the opposite reactor wall 2. In the embodiment shown in FIG. 6, this corresponds to a displacement 16 substantially perpendicularly with respect to the opposite reactor wall 2. In this way, by the displacement 16 of the gliding wall 9″, the (shortest) distance between the gliding wall 9″ and the first reactor wall 2 is adjusted, and therefore so is the gap dimension D between the end side 13 of the gliding wall 9″ facing the flow and the opposite reactor wall 2. In other words, by displacement 16 of the gliding wall 9″, the layer thickness D of the liquid 4 flowing through the irradiation zone 12″ can be changed, in particular adapted to different degrees of turbidity of the liquid (or in general of the fluid).

In order to measure the degree of turbidity, a turbidity sensor 7 is provided, which is arranged on the reactor wall 3 opposite the UV-C LEDs 1. Alternatively, the turbidity sensor 7 may also be arranged on the end side 13 of the gliding wall 9″ that faces toward the liquid flow 8 (this is not represented). This arrangement sometimes has the advantage that the signal of the turbidity sensor 7 cannot be affected by shadowing by the gliding wall 9″ either. Furthermore, besides sensors for the direct radiation, additional sensors may also be provided for scattered or back-scattered radiation.

In one variant, the UV-C LEDs are arranged on the end side of the gliding wall that faces toward the liquid flow (this is not represented). This variant has the advantage over the embodiment represented in FIG. 6 that no UV-C radiation travels past the gliding wall.

In a further variant, an additional second gliding wall is provided, which is arranged opposite the first gliding wall and can be displaced like the latter (this is not represented). In this case, the gap dimension can be adjusted in a defined way via the distance between the mutually facing end sides of the two gliding walls. In this case, it is particularly advantageous to displace the two gliding walls symmetrically for the respective desired gap dimension. In this way, the flow symmetry of the reactor can be preserved.

One advantage of these embodiments with at least one gliding wall as a displaceable body, over the conical shape presented previously in FIGS. 4 and 5, is that the number of UV-C LEDs 1 can be equally distributed along the irradiation zone. Because of the plane geometry of the walls that delimit the irradiation zone, the distance between the individual LEDs then also remains constant. With the conical shape, on the other hand, for uniform irradiation the number of LEDs along the lateral surface of the cone must likewise increase correspondingly with the increasing circumference (as considered from the cone apex) so that the distance between the individual LEDs in the circumferential direction remains constant.

In a further variant, lastly, the UV-C LEDs are arranged on both sides of the liquid layer, on the reactor walls that delimit this liquid layer. It is thus a UV flow reactor with bilateral UV irradiation of the liquid layer. A more uniform UV intensity distribution may therefore be achieved in the reactor transversely with respect to the flow direction of the liquid layer.

A device for sterilizing a fluid flowing through by means of UV radiation (UV reactor) comprises a container having an inlet for receiving the fluid and having an outlet for discharging the fluid from the container, a variable or adjustable irradiation zone for irradiation of the fluid with UV radiation being provided inside the container. The irradiation zone is formed as a gap, which extends between two reactor walls arranged facing one another and through which the fluid flows. The distance (D) between the reactor walls, and therefore also the gap dimension (D) of the gap, is variable by at least one reactor wall being designed to be movable. For example, the movable reactor wall is a wall of a displaceable body arranged inside the container or projecting into the container. By adaptation of the distance between the reactor walls in the region of the gap-shaped irradiation zone, and therefore of the layer thickness (D) of the liquid flowing through the gap, efficiency-optimized operation of the UV reactor is achieved in the event of different scattering and absorption properties of the fluid. Optionally, the penetration depth of the radiation is detected with a sensor and the gap dimension (D) is appropriately adapted with the aid of the sensor signal.

### LIST OF REFERENCES

1, 1′ UV radiation source
2 first reactor wall
3 second reactor wall
4 liquid
6 UV radiation
7 radiation sensor
8 flow direction
   9, 9′, 9″ displaceable body; wedge-shaped or
   conical slider; gliding wall
10, 10′, 10″ reactor
12, 12′, 12″ first reactor region; irradiation zone
13 end side of the gliding wall
14, 14′ oblique or conical slider wall
16 displacement direction
18, 18′ second reactor region
20, 20′ container; reactor chamber
22 inlet
24 outlet
26, 26′ oblique/funnel-shaped container wall
28 turbidity sensor
30 control unit
32 three-way valve
34 bypass tube
36 slide bearing
38 indentation
40 retaining spring
   D distance between the walls in the
   irradiation zone; gap dimension
A axis

1. A device for sterilizing a fluid flowing through by means of UV radiation, comprising:
a container having an inlet for receiving the fluid and having an outlet for discharging the fluid from the container,
wherein an irradiation zone for irradiation of the fluid is provided inside the container,
a multiplicity of radiation sources, each of which is configured to emit light having wavelengths in a range of UV radiation into the irradiation zone,
wherein the irradiation zone is formed as a gap,
wherein the container is designed for the fluid to flow through the gap, and
wherein the irradiation zone is designed for a gap dimension of the gap to be variable.

2. The device as claimed in claim 1, wherein the gap is formed by walls arranged facing one another, and wherein a distance between the walls is variable.

3. The device as claimed in claim 2, wherein one of the walls arranged facing one another is a wall of the container.

4. The device as claimed in claim 2, wherein one of the walls arranged facing one another is a wall of a displaceable body which is arranged at least partially inside the container.

5. The device as claimed in claim 2, wherein the shapes of the walls arranged facing one another are matched to one another so that the gap between the walls is formed uniformly at least in sections inside the entire irradiation zone.

6. The device as claimed in claim 4, further comprising a displacement unit designed to displace the displaceable body in relation to the wall of the container so that the gap dimension changes uniformly inside the irradiation zone.

7. The device as claimed in claim 6, wherein the displaceable body is mechanically coupled to the displacement unit, the displaceable body being supported movably in a linear guide rail.

8. The device as claimed in claim 6, wherein the displaceable body is magnetically coupled to the displacement unit through the container.

9. The device as claimed in claim 6, wherein the displacement unit is designed to allow displacement of the displaceable body a force of the flowing fluid.

10. The device as claimed in claim 9, wherein the displacement unit comprises a bypass for the fluid, and wherein the bypass is designed to convey the fluid to a rear side of the displaceable body facing away from the inlet.

11. The device as claimed in claim 4, wherein the body is suspended inside the container by damping or restoring elements.

12. The device as claimed in claim 4, wherein the displaceable body has, at least in sections, a shape of a wedge or cone or a plane wall.

13. The device as claimed in claim 12, wherein the plane wall is displaceable through an opening in a wall of the container transversely with respect to the flow direction of the fluid flowing through the gap-shaped irradiation zone and toward an oppositely arranged other wall of the container, wherein the gap-shaped irradiation zone is formed between an end side of the displaceable wall and an oppositely arranged wall, and wherein the gap dimension can be varied by displacement of the displaceable wall.

14. The device as claimed in claim 1, having a first plane wall, which is displaceable through an opening in a first wall of the container, and having a second plane wall, which is displaceable through an opening in a second wall of the container, wherein the first plane wall and the second plane wall are arranged so that they face one another respectively with respective end sides, and wherein the irradiation zone having the gap dimension is formed between the respective end sides of the two displaceable walls.

15. The device as claimed in claim 1, wherein the container, the walls, and/or the body consists or consist at least partially of a material that is transparent for the light emitted by the radiation sources.

16. The device as claimed in claim 1, further comprising a sensor designed to measure a property of the fluid.

17. The device as claimed in claim 6, further comprising a sensor designed to measure a property of the fluid, wherein the displacement unit is driven as a function of a measurement signal of the sensor.

18. A method for sterilizing a flowing fluid, comprising:
providing a device as claimed in claim;
connecting the inlet of the device to a source of the fluid and connecting the multiplicity of radiation sources to an electrical energy supply source;
delivering the fluid into the container through the inlet;
letting the fluid flow through the irradiation zone and irradiating the fluid with the UV radiation, of the radiation sources; and
adapting the gap dimension of the irradiation zone to at least one property of the fluid.

19. The method as claimed in claim 18, additionally comprising:
measuring the at least one property of the fluid with aid of a sensor, and using a measurement signal of the sensor in order to adapt the gap dimension.

20. The method as claimed in claim 18, additionally comprising:
returning the fluid to the source or into another reservoir via the an outlet.
